(19) United States
(12) Patent Application Publication
(10) Pub. No.: US 2023/0245024 A1
(43) Pub. Date: Aug. 3, 2023

(54) BUILDING ENERGY MANAGEMENT SYSTEM USING SALES DATA

(71) Applicant: SMARTCAST Co., Ltd, Goyang-si (KR)

(72) Inventor: Sang Hyun HWANG, Daejeon (KR)

(21) Appl. No.: 18/059,327

(22) Filed: Nov. 28, 2022

(30) Foreign Application Priority Data
Jan. 28, 2022 (KR) 10-2022-0012894
Jan. 28, 2022 (KR) 10-2022-0012895

(51) Int. Cl. G06Q 10/06; G06Q 30/02

(52) U.S. Cl. CPC G06Q 10/06315; G06Q 30/0206

(57) ABSTRACT

The present invention relates to a building energy management system using sales data. The building energy management system using sales data according to the present invention includes a store environment data collection unit configured to collect environmental data of a store located in the building, a sales data collection unit configured to collect sales data generated at the store, a data analysis unit configured to analyze the environmental data and the sales data to provide an analysis result, and an energy saving model derivation unit configured to derive an energy saving model by using the analysis result.

### CROSS-REFERENCE TO RELATED APPLICATION

This application claims priority to and the benefit of Korean Patent Application Nos. 10-2022-0012894 filed on Jan. 28, 2022, and 10-2022-0012895 filed on Jan. 28, 2022, the disclosure of which is incorporated herein by reference in its entirety.

### 1. Field of the Invention

The present invention relates to a building energy management system using sales data.

### 2. Discussion of Related Art

A building energy management system (BEMS) is a system that includes sensors and measurement equipment installed in energy using devices in buildings such as lighting, heating and cooling facilities, and outlets and connects the sensors and the measurement equipment through a communication network to automatically control the sensors and the management equipment by the most efficient management method. Through the building energy management system, it is possible to manage how much energy is used and how much carbon is emitted and manage an indoor environment of the building and an operating status of facilities.

Data on the total amount of energy used in buildings and data on energy use for each store may be easily identified through bills, watt-hour meters, and the like. In order to check the occurrence of energy peak times for each store type in a shopping mall, in the past, only energy consumption was checked in real time. However, in order to analyze what kind of environmental factors cause changes in energy use and to simultaneously identify causes of occurrence of energy peaks, it is necessary to secure sales and cooking data that occur in actual stores to be able to accurately understand the relationship with energy.

According to the related art, there is a problem in that it is not possible to generate accurate analysis data on an energy consumption rate, and since store owners do not know how much energy their store consumes compared to the same type of stores, there is a problem in that these shop owners excessively pay unnecessary basic fees according to contract power. In other words, when the contract power of the store does not match characteristics of a branch and is set too high, the stop owner are obliged to unnecessarily pay large base fees every month. For example, referring to a price table according to the contract power and the maximum monthly power consumption, the basic fee is set at about 6,000 won per 1 kW of contract power. Even if the contract power is set relatively high by only 5 kW, there is a problem in that the store owner needs to make unnecessary payments of about 30,000 won per month and about 390,000 won a year. When looking at the status of the contract power for each store, it was confirmed that 47.8% of restaurants, 92.9% of hairdressers, and 78.5% of cafes that are subjects of investigation need to adjust their contract power downwards.

### SUMMARY OF THE INVENTION

The present invention provides a building energy management system using sales data capable of collecting and analyzing store environment data and sales data to generate accurate analysis data on an energy consumption rate and using the generated analysis data to derive an energy saving model.

According to an aspect of the present invention, a building energy management system using sales data includes: a store environment data collection unit configured to collect environmental data of a store located in the building; a sales data collection unit configured to collect sales data generated at the store; a data analysis unit configured to analyze the environmental data and the sales data to provide an analysis result; and an energy saving model derivation unit configured to derive an energy saving model by using the analysis result.

The store environment data collection unit may collect the environment data including at least one of store type information, size information, and cooking method information for each menu.

The sales data collection unit may collect the sales data including at least one of order menu information, quantity information, order type information, and variable information.

The data analysis unit may receive energy use data, synchronize the energy use data with the environmental data and the sales data to generate basic data, and perform analysis on the basic data.

The data analysis unit may receive use history information of a user, and generate and provide recommendation information for use to the user in consideration of the environment data, the sales data, and the energy use data, in which the recommendation information may include at least one of recommendation information for a store visit time and benefit information.

### BRIEF DESCRIPTION OF THE DRAWINGS

FIG. 1 is a diagram illustrating a configuration of a building energy management system using sales data according to an embodiment of the present invention.

FIG. 2 is a diagram illustrating a configuration related to a collection and utilization of sales data for each store according to an embodiment of the present invention.

FIG. 3 is a diagram illustrating a building energy management method using sales data according to an embodiment of the present invention.

FIG. 4 illustrates a system for predicting store energy consumption and providing a customer recommendation service based on unit energy consumption analysis for each menu according to another embodiment of the present invention.

FIG. 5 illustrates a method of predicting store energy consumption and providing a customer recommendation service based on unit energy consumption analysis for each menu according to another embodiment of the present invention.

### DETAILED DESCRIPTION OF EXEMPLARY EMBODIMENTS

The above-mentioned aspect, and other aspects, advantages, and features of the present disclosure and methods accomplishing them will become apparent from the following detailed description of exemplary embodiments with reference to the accompanying drawings.

However, the present invention may be modified in many different forms and it should not be limited to the exemplary embodiments set forth herein. Only the following embodiments are provided to easily inform those of ordinary skill in the art to which the present invention pertains of the object, configuration and effect of the invention, and the scope of the present invention is defined by the description of the claim.

Meanwhile, terms used in the present specification are for explaining exemplary embodiments rather than limiting the present disclosure. Unless otherwise stated, a singular form includes a plural form in the present specification. Components, steps, operations, and/or elements mentioned by terms “comprise” and/or “comprising” used in the present invention do not exclude the existence or addition of one or more other components, steps, operations, and/or elements.

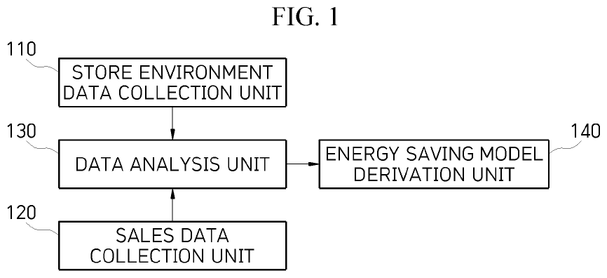

FIG. 1 is a diagram illustrating a configuration of a building energy management system using sales data according to an embodiment of the present invention.

According to an embodiment of the present invention, it is possible to generate basic data by subdividing store information and sales data based on a type of stores in a shopping mall and synchronizing a relationship between data collected in real time and energy use data, and generate and utilize a public data model by deriving a model capable of saving consumed energy such as cooling/heating and cooking by analyzing the generated data.

According to an embodiment of the present invention, it is possible to accurately analyze an energy consumption rate based on average sales data by time/day of the week/day/month according to type information (Chinese food, Korean food, Japanese food, etc.) of a store, size information, commercial area information (office, residential, downtown, etc.), and store environment data including cooking type information (electric heat, fire pit, etc.).

According to an embodiment of the present invention, by collecting/storing sales data and basic data of stores in a building together and providing the collected/stored sales data to private operators in a shared data method, development and utilization of new energy saving solutions, services, or the like is supported.

The store environment data collection unit 110 collects store type information, size information, cooking method information for each menu, and other information. The store type information may include Korean food, Japanese food, Chinese food, snack food, and the like, and the size information may include size information within 5 pyeong, 6 to 10 pyeong, 11 to 20 pyeong, 21 to 30 pyeong, and 31 pyeong or more, and the cooking method information for each menu may include a fire pit, an oven, a fryer, and a general electric heater, and other information may include the number of employees and commercial area information.

The sales data collection unit 120 collects order menu/quantity information, order type information, and other variable information. The order menu/quantity information may include a menu, a quantity, and unit price information that matches the cooking method, the order type information may include store orders, takeout, and delivery orders, and other variable information may include a sales type, a credit card company, pre-prepared materials for each day of the week (weekdays, holidays, national holidays, etc.), and GIS information (weather, etc.).

The data analysis unit 130 according to the embodiment of the present invention analyzes store environment data and sales data, and transmits the analysis result.

The energy saving model derivation unit 140 predicts energy consumption using the analysis results (energy consumption of a store and sales data), and establishes an energy operation plan such as automatic control of air conditioners and freshness management of food materials.

According to an embodiment of the present invention, the energy saving model derivation unit may be linked with a user device to provide recommendation information to the user device by considering preference information of a user located in a building, preferred meal time information, and preferred menu information (history information of using a store in the past) and considering store use information (waiting information of current time, preset time-30 minutes, expected waiting information after 1 hour, information on cooling/heating operation by area in a store, whether customers can be seated in each compartment in the store considering social distancing, etc.). For example, it is possible to provide current waiting information and recommended visit time information of store A in a shopping mall to a user who has eaten lunch at the store A more than a certain number of times compared to the number of visits to a specific shopping mall. By providing a reservation function using the user device, it is possible to concentrate or disperse customer visits in consideration of a time period when energy use efficiency is high. For example, by providing benefits (discount coupons, etc.) when visiting at a specific recommended visit time, there is an effect that it is possible to provide store operation and recommended information to increase the efficiency of store operation and energy management.

A method of utilizing sales data in an energy field according to an embodiment of the present invention can provide an energy analysis and standard consumption model (guideline) providing service based on a size, a type, and sales of stores in the building, a store energy consumption model providing service based on analysis of sales composition for each service type (hall/delivery, etc.), an energy prediction service through resident pattern/propensity analysis based on store sales analysis in a building, a building energy consumption analysis and prediction service according to regional and seasonal sales characteristics, a building energy consumption analysis and prediction service based on sales characteristics by day of the week and time, a store energy consumption prediction service based on unit energy consumption analysis for each menu, a standard energy consumption model providing service based on store/sales size for each franchise store, and a store energy management solution service through food material demand forecasting by store.

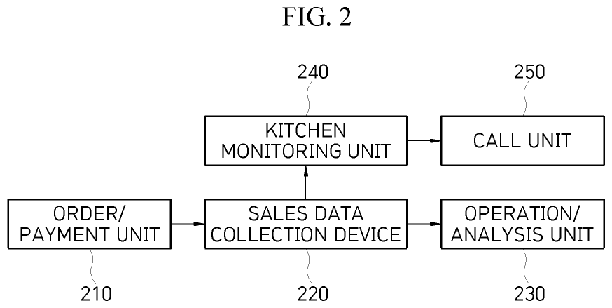

FIG. 2 is a diagram illustrating a configuration related to a collection and utilization of sales data for each store according to an embodiment of the present invention.

The order/payment unit 210 corresponds to a front end that provides an order/payment solution, and receives data generated in all order paths through POS, kiosk, delivery app, and the like.

The sales data collection device 220 collects order data by scraping serial data by bridging an order receipt with a printer cable connected to an order receiving device, and transmits the collected order data to a kitchen monitoring unit 240.

The kitchen monitoring unit 240 displays order information and is connected to a call unit 250 to provide a DID display, a customer call, a notification service, and the like.

The operation/analysis unit 230 receives data from the sales data collection device 220 and provides a big data and AI-based analysis solution.

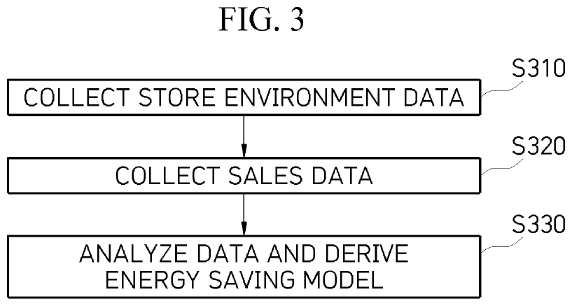

FIG. 3 is a diagram illustrating a building energy management method using sales data according to an embodiment of the present invention.

The building energy management method using sales data according to an embodiment of the present invention includes a step (S310) of collecting store environment data, a step (S320) of collecting sales data, and a step (S330) of analyzing data and deriving an energy saving model.

In step S310, store type information, size information, cooking method information for each menu, and other information (the number of employees and commercial area) are collected.

In step S320, order menu and quantity information, order type information, and other variable information (sales type, credit card company, pre-prepared materials for each day of the week, weather information) are collected.

In step S330, an energy operation plan including automatic control of air conditioners and freshness management of food materials is established by analyzing the store environment data and the sales data.

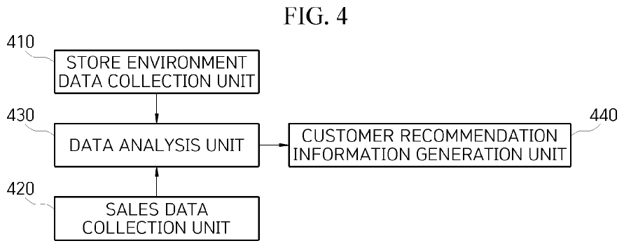

FIG. 4 illustrates a system for predicting store energy consumption and providing a customer recommendation service based on unit energy consumption analysis for each menu according to another embodiment of the present invention.

A store environment data collection unit 410 collects store type information, size information, menu information, cooking method information for each menu, and other information. As described above, the store type information may include Korean food, Japanese food, Chinese food, snack food, and the like, and the size information may include size information within 5 pyeong, 6 to 10 pyeong, 11 to 20 pyeong, 21 to 30 pyeong, and 31 pyeong or more, the menu information may include information on menus handled by each store, and the cooking method information for each menu may include a fire pit, an oven, a fryer, and a general electric heater, and other information may include the number of employees and commercial area information. In addition, the store environment data collection unit 410 collects cooking information for each menu, energy information expected during cooking for the corresponding menu, and energy information used during actual cooking.

The sales data collection unit 420 collects order menu/quantity information, order type information, and other variable information. The order menu/quantity information may include a menu, a quantity, and unit price information that matches the cooking method, the order type information may include store orders, takeout, and delivery orders, and other variable information may include a sales type, a credit card company, pre-prepared materials for each day of the week (weekdays, holidays, national holidays, etc.), and GIS information (weather, etc.).

A data analysis unit 430 according to another embodiment of the present invention performs analysis using the store environment data received from the store environment data collection unit 410 and the sales data received from the sales data collection unit 420 and transmits the analysis result to the customer recommendation information generation unit 440.

The data analysis unit 430 derives a unit energy consumption analysis result for each menu using the store environment data and the sales data, and predicts the energy consumption of the corresponding store based on the unit energy consumption analysis result.

A customer recommendation information generation unit 440 generates customer recommendation information by using the store energy consumption information predicted based on the unit energy consumption analysis for each menu. In this case, the customer recommendation information generation unit 440 generates, based on the analysis results of the data analysis unit 430, menus to be recommended to customers, a combination of menus, and discount information (or additionally accumulated information) of menus according to each time point by referring to a workload of a clerk in a store at a current point in time or within a certain amount of time (e.g., 25 minutes) from the current point in time, an expected waiting time of a customer, an expected delivery time, and energy consumption prediction information. For example, it is assumed that unit energy consumption for menus A and B is 1, and unit energy consumption for menus C and D is 0.5. The customer recommendation information generation unit 440 can recommend and provide discounts for menus C and D in consideration of considers history information of energy consumption for one month, unit energy consumption for each menu, cost occurrence information according to the energy consumption, an expected margin for each menu, and the like, or recommend a discount service provided when the menu A and menu C are combined.

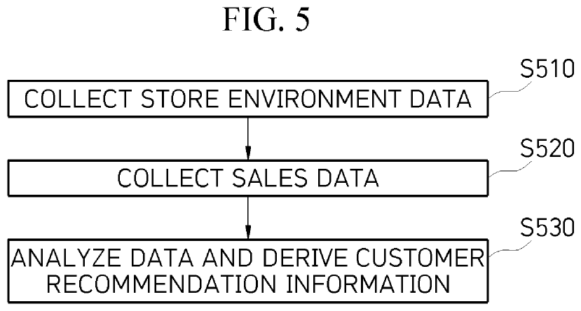

FIG. 5 illustrates a method of predicting store energy consumption and providing a customer recommendation service based on unit energy consumption analysis for each menu according to another embodiment of the present invention.

The method of predicting store energy consumption and providing a customer recommendation service based on unit energy consumption analysis for each menu according to another embodiment of the present invention includes a step (S510) of collecting store environment data, a step (S520) of collecting sales data, and a step (S530) of analyzing the data and deriving customer recommendation information.

In step S510, the store type information, the size information, the menu information, the cooking method information for each menu, and other information (the number of employees and commercial area) are collected.

In step S520, order menu and quantity information, order type information, and other variable information (sales type, credit card company, pre-prepared materials for each day of the week, weather information) are collected.

In step S530, by generating the store environment data and the sales data, the store energy consumption information based on unit energy consumption analysis for each menu is predicted, and the menu information to be recommended to customers is generated.

Meanwhile, the method according to the embodiment of the present invention may be implemented in a computer system or recorded in a recording medium. The computer system may include at least one processor, a memory, a user input device, a data communication bus, a user output device, and storage. Each of the above-described components performs data communication through the data communication bus.

The computer system may further include a network interface coupled to a network. The processor may be a central processing unit (CPU) or a semiconductor device that processes instructions stored in the memory and/or storage.

The memory and storage may include various types of volatile or non-volatile storage media. For example, the memory may include a read only memory (ROM) and a random access memory (RAM).

Accordingly, the method according to the embodiment of the present invention may be implemented as a computer-executable method. When the method according to the embodiment of the present invention is performed in the computer device, computer-readable instructions may perform the method according to the present invention.

Meanwhile, the method according to the embodiment of the present invention described above may be implemented as a computer-readable code in a computer-readable recording medium. The computer-readable recording medium includes any type of recording medium in which data readable by a computer system is stored. For example, there may be a ROM, a RAM, a magnetic tape, a magnetic disk, a flash memory, an optical data storage device, and the like. In addition, the computer-readable recording medium may be distributed in computer systems connected through a computer communication network, and stored and executed as readable codes in a distributed manner.

According to another embodiment of the present invention, order menu information management for generating building energy management information, providing customer recommendation information, and processing an order received from a customer device is performed.

An order menu information management server according to another embodiment of the present invention includes an input unit for receiving order menu information, and a memory in which a program for generating electronic order form information using order menu information is stored, and a processor for executing the program. The processor transmits the electronic order form information to the customer terminal, and receives and manages review content written by the customer terminal for the electronic order form information.

The input unit receives order menu information including order menu and quantity information. The processor generates the electronic order form information including at least one of menu image information, menu price information, and menu description information by using the order menu information. The processor maps the order menu information and the menu information pre-stored in the database to extract at least one of the menu image information, the menu price information, and the menu description information. The processor generates the electronic order form information including preset tag information. The processor shares the review content with a portal service providing server. The processor generates individual propensity information by using the review content, and generates location-based recommendation information using the individual propensity information. When the processor receives the review content, the processor pays a reward to the corresponding customer account or provides a notification of reward payment to an affiliated store terminal. The processor analyzes the review content, and differentially pays a reward to the corresponding restaurant account according to the analysis result.

As the customer completes an order, the order menu information is transmitted from the affiliated store terminal to a server. In this case, the affiliated store terminal is an order receiving terminal having a communication function, and the order receiving terminal transmits order menu information to a kitchen terminal and also transmits the order menu information to the server. The server generates the electronic order form information using the order menu information, and transmits the generated electronic order form information to the customer terminal. When the electronic order form information is transmitted, information related to convenience services provided from affiliated stores to customers may be additionally transmitted, and the information related to convenience services may include information on the affiliated store environment, such as an in-store wireless Internet password and a password for toilet lock. In addition, when the electronic order form information is transmitted, event information, campaign information, etc., preset by the affiliated store may be additionally transmitted. The electronic order form information is preferably provided in the form of a mobile web page, and can also be provided through an application. When a customer places an order, a phone number of a customer terminal to receive the electronic order form information is received, and the order menu information including the phone number is transmitted to the server. In this case, the customer transmits a single or a plurality of phone numbers, so it is possible to share the electronic order form information with parties in the same table. The server determines whether the corresponding phone number corresponds to the actual customer's phone number by using the location information of the customer terminal. For example, the server checks a first phone number and a second phone number among the phone numbers included in the order menu information, checks the location information of the customer terminal corresponding to each phone number, and checks whether the customer terminal corresponding to the corresponding phone number exists in locations of a restaurant, a cafe, a food court, etc., corresponding to the order menu information. Even if the server is a phone number included in the order menu information, when it is checked that the customer terminal 200 is not located in a place corresponding to the order menu information, the electronic order form information is not transmitted, so spam messages (spam-like electronic order form information) due to incorrect phone number input are prevented from being sent. Alternatively, when delivering the customer's phone number, it is possible to receive customer terminal information from a customer terminal, such as reading a QR code generated by a customer terminal instead of a phone number input method, and transmit an electronic order form to the corresponding customer terminal.

When the server receives the order menu information, the server matches the order menu information with the information pre-stored in the database to generate the electronic order form information including at least one of the menu image information, the menu price information, and the menu description information, and transmit the generated electronic order form information to the customer terminal 200. In addition, the server generates electronic order form information including preset tag information, and transmits the generated electronic order form information to the customer terminal. That is, the server generates electronic order form information including preset hash tag information and transmits the generated electronic order form information to the customer terminal, and thus, generates and transmits/shares review content including automatically input hashtag information without needing to manually write and input a hashtag phrase specified at the point in order to enable a customer to directly receive a reward (e.g., beverage service) at a customer terminal. The customer terminal generates the review content based on the electronic order form information. The electronic order form includes a review writing column for each corresponding menu, and when a review for each corresponding menu is input, the customer terminal generates the review content based on the review. When the review content is generated from the customer terminal, the server receives and stores the review content. Customers may publish review content written on the basis of a web page through their SNS, and it is also possible to write review content through an application.

The server transmits review content to a portal service providing server so that the review content may be registered as an actual user review of the corresponding point. The server generates electronic order form information based on the order menu information and shares the review content written based on the generated electronic order form information, so a customer may register the review as an actual user review without a separate receipt authentication process. The server manages customer information (age, gender, region, etc.) under the consent to use personal information, and generates/manages customer preference information by analyzing review contents. Through this, when a customer visits a new place in consideration of the customer's preference information, restaurant information and menu information that the customer may prefer among restaurants in the surrounding area may be generated as recommendation information, and the recommendation information may be transmitted to the customer terminal.

In addition, the server classifies a plurality of customers by category using the customer information and review content writing history information, generates recommended information including restaurant information and menu information that the classified customers may prefer, and transmit the recommended information to the customer terminal. When the reception of the review content is completed, the server pays a reward (e.g., points) to an account of a customer who writes the review content. For the shared review content, when consent information of other users for “the review was helpful” exceeds the preset number of times, the server assigns an additional reward to an account of a customer who has left the review content according to a preset method, thereby improving the quality of review contents. In addition, when the reception of the review content is completed, the server transmits the review content reception completion to the affiliated store terminal. Accordingly, the customer may receive a promised reward (e.g., beverage service provision) without directly showing an SNS review post to a store clerk for review writing items. The server analyzes the review content and pays a reward to the affiliated store based on the evaluation score. For example, when the evaluation score (star point) in the review content is out of 5 points, 5 points are paid as an affiliated store reward, and when the evaluation score (star point) is 4 points, 4 points are paid as an affiliated store reward. That is, the server differentially pays rewards to the affiliated stores based on the evaluation score included in the review content.

When an affiliated store use rewards (points) received from the server for search, the affiliated store information may be inquired at the top, or the corresponding points may be used when posting advertisements.

For the reward paid to the affiliated store, the evaluation score included in the review content may be reflected as it is, and it is possible that the evaluation score is weighted and reflected based on reliability information of a review writer. For example, in the case of a review writer who wrote the lowest evaluation score for all stores that have written the review content, the review writer is determined as a black consumer, and a preset weight a is reflected in the evaluation score, so the affiliated store reward corresponding to the evaluation score 1 point ▭ weight a, that is, the corrected evaluation score a is paid. In addition, in the case of the review writer who wrote the highest evaluation score for all the stores that wrote the review content, a preset weight b is reflected in the evaluation score, so the affiliated reward corresponding to the evaluation score 5 points ▭ weight b, that is, the corrected evaluation score 5b is paid. In this way, it is possible to assign a reward to the affiliated store in consideration of an evaluation score pattern (reliability information) of the consumer who wrote the review content. According to another embodiment of the present invention, the reward is assigned to the affiliated stores according to the evaluation items included in the actual user review, so the affiliated store may receive rewards according to the positive evaluation of the customer, thereby improving the service quality.

According to the present invention, by generating and utilizing accurate and real-time numerical data related to stores, it is possible to more sophisticatedly perform pattern analysis of energy use, predict the amount of electricity to be consumed with high reliability even if a store in a shopping mall or the like is changed, and utilize data analysis results as evidence data for energy saving factors for each store.

The effects of the present invention are not limited to those described above, and other effects not described can be clearly understood by those skilled in the art from the following description.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A building energy management system using sales data, comprising:
a store environment data collection unit configured to collect environmental data of a store located in the building;
a sales data collection unit configured to collect sales data generated at the store;
a data analysis unit configured to analyze the environmental data and the sales data to provide an analysis result; and
an energy saving model derivation unit configured to derive an energy saving model by using the analysis result.

2. The building energy management system using sales data of claim 1, wherein the store environment data collection unit collects the environment data including at least one of store type information, size information, and cooking method information for each menu.

3. The building energy management system using sales data of claim 1, wherein the sales data collection unit collects the sales data including at least one of order menu information, quantity information, order type information, and variable information.

4. The building energy management system using sales data of claim 1, wherein the data analysis unit receives energy use data, synchronizes the energy use data with the environmental data and the sales data to generate basic data, and performs analysis on the basic data.

5. The building energy management system using sales data of claim 4, wherein the data analysis unit receives use history information of a user, and generates and provides recommendation information for use to the user in consideration of the environment data, the sales data, and the energy use data, the recommendation information including at least one of recommendation information for a store visit time and benefit information.
